(19) United States
(12) Patent Application Publication
(10) Pub. No.: US 2012/0137361 A1
(43) Pub. Date: May 31, 2012

(54) NETWORK SECURITY CONTROL SYSTEM AND METHOD, AND SECURITY EVENT PROCESSING APPARATUS AND VISUALIZATION PROCESSING APPARATUS FOR NETWORK SECURITY CONTROL

(75) Inventors: Sungwon YI, Daejeon (KR); Ki Young Kim, Daejeon (KR); Gaeil An, Daejeon (KR); Jonghyun Kim, Daejeon (KR)

(73) Assignee: ELECTRONICS AND TELECOMMUNICATIONS RESEARCH INSTITUTE, Daejeon (KR)

(21) Appl. No.: 13/198,215

(22) Filed: Aug. 4, 2011

(30) Foreign Application Priority Data
Nov. 26, 2010 (KR) 10-2010-0118632

(51) Int. Cl. G06F 21/00; G06F 15/16

(52) U.S. Cl. 726/22

(57) ABSTRACT

A network security control system includes: a network event generator for generating network events; a security event processing apparatus for collecting the network events from the network event generator via a network and processing the collected network events as a target data for visualization; and a visualization processing apparatus for visualizing the target data to display a security status as a third-dimensional (3D) visualization information on an organization basis.

### CROSS-REFERENCE(S) TO RELATED APPLICATION(S)

The present invention claims priority of Korean Patent Application No. 10-2010-0118632, filed on Nov. 26, 2010, which is incorporated herein by reference.

### FIELD OF THE INVENTION

The present invention relates to a network security control technology; and, more particularly, to a network security control system and method for displaying, in consideration of the degree of security threat, network events collected from security apparatuses as 3D visualization information on a multi-disc structure.

### BACKGROUND OF THE INVENTION

In a conventional network security control system, a network security event is represented as a single-line form using a source internet protocol (IP), ports used, a protocol, a destination IP of the network security event. Thus, security events of an entire network can be displayed as visualization information in terms of IP.

Such a security visualization using IPs may provide detailed information regarding each IP, but does not present internet service providers (ISPs), and security statuses for subdivisions of target organizations. Also, administrators have to cope with each IP for security measures, thus resulting in inefficient countermeasures.

### SUMMARY OF THE INVENTION

In view of the above, the present invention provides a network security control technology for displaying in real-time a network security status on an organization basis by collecting network events to display them as 3D visualization information in consideration of the degree of security threat on a multi-disc structure.

In accordance with a first aspect of the present invention, there is provided a network security control system, including:

a network event generator for generating network events;

a security event processing apparatus for collecting the network events from the network event generator via a network and processing the collected network events as a target data for visualization; and

a visualization processing apparatus for visualizing the target data to display a security status as a third-dimensional (3D) visualization information on an organization basis.

In accordance with a second aspect of the present invention, there is provided a security event processing apparatus for a control of a network security, including:

a security event classification unit for classifying network events supplied thereto into zombie PC logs and other security logs according to the kind of security event;

an organization information search unit for searching for organization information based on the security event classified by the security event classification unit; and

a security event summarization unit for selecting target data for visualization among the security logs, in consideration of the organization information searched by the organization information search unit and the degree of security threat.

In accordance with a third aspect of the present invention, there is provided a visualization processing apparatus for a control of a network security, including:

a 3D security visualization unit for displaying, on a multi-disc structure, 3D visualization information representing security status of network events;

a target display unit for displaying visualization information indicating a target organization displayed by the 3D security visualization unit; and

an additional information display unit for displaying summarized security information regarding the target organization displayed by the 3D security visualization unit.

In accordance with a fourth aspect of the present invention, there is provided a network security control method, including:

classifying network events according to the kind of security event when the network events have occurred;

searching for organization information based on the classified network events;

selecting target data for visualization among the classified network events in consideration of the searched organization information and the degree of security threat; and

displaying the selected target data as 3D visualization information on a multi-disc structure.

### BRIEF DESCRIPTION OF THE DRAWINGS

The objects and features of the present invention will become apparent from the following description of embodiments, given in conjunction with the accompanying drawings, in which:

FIG. 1 is a block diagram showing a configuration of a network security system in accordance with an embodiment of the present invention.

FIG. 2 is a block diagram showing a detailed configuration of a security event processing apparatus shown in FIG. 1.

FIG. 3 is a block diagram showing a detailed configuration of a visualization processing apparatus shown in FIG. 1.

FIG. 4 shows an example of a display output through a target display radar unit shown in FIG. 3.

FIG. 5 depicts an example of a display output through an additional information display unit shown in FIG. 3.

FIG. 6 illustrates an example of a display output of a 3D disc structure through a 3D security status visualization unit shown in FIG. 3.

FIG. 7 shows an example of displaying attack types and attack names on the 3D disc structure shown in FIG. 6.

### DETAILED DESCRIPTION OF THE EMBODIMENTS

Hereinafter, embodiments of the present invention will be described with reference to the accompanying drawings which form a part hereof.

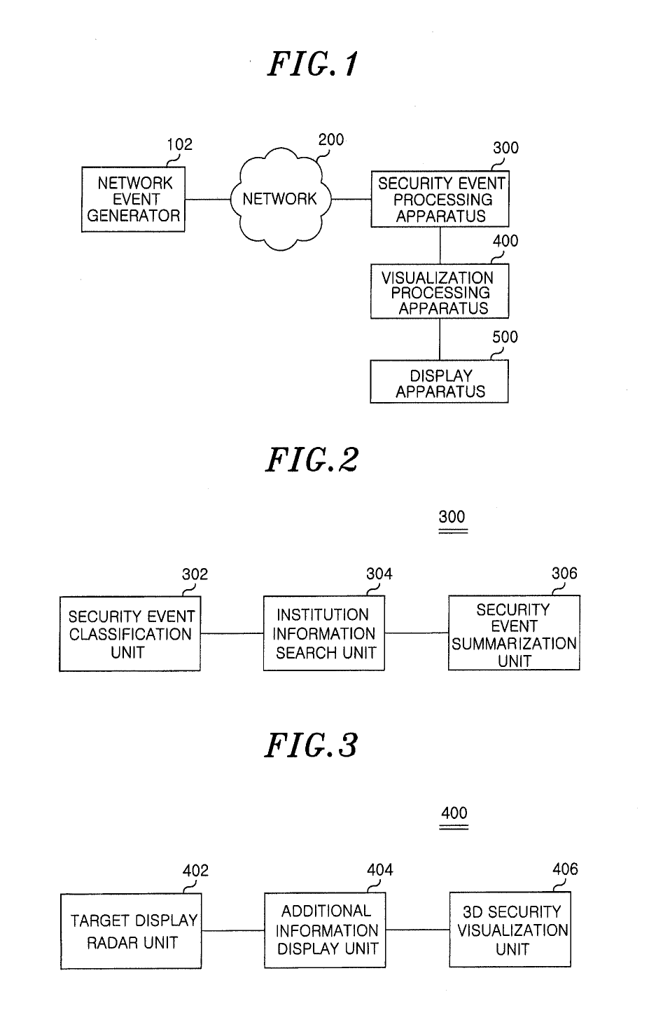

FIG. 1 is a block diagram showing a configuration of a network security system in accordance with an embodiment of the present invention. The network security system includes a network event generator 100, a network 200, a security event processing apparatus 300, a visualization processing apparatus 400, and a display apparatus 500.

As shown in FIG. 1, the network event generator 100 generates network events to transmit it to the security event processing apparatus 300 via the network 200. The network events refer to security logs generated by various security apparatuses or systems. The network event generator 100 may include, for example, a traffic monitoring device, a firewall system, an intrusion detection system (IDS), an intrusion preventing system (IPS), a distribute denial of service (DDoS) detection/response system and the like.

The network 200 may include a broadband network and a short distance network and the like, and provides communication environment which enables to transmit the network events generated by the network event generator 100 to the security event processing apparatus 300.

Here, the broadband network includes a wireless broadband network and a wired broadband network.

The wireless broadband network includes a base station, a base station controller, and a mobile communication system which supports both a synchronous manner and an asynchronous manner. The wireless broadband network is, however, not limited to that, and may include a Global System for Mobile communications (GSM) and access networks of all kind of mobile communication systems to be implemented in the future.

The wired broadband network has a worldwide open computer network structure providing Transmission Control Protocol/Internet Protocol (TCP/IP) and various services of upper layers, such as Hypertext Transfer Protocol (HTTP), telnet, File Transfer Protocol (FTP), Domain Name System (DNS), Simple Mail Transfer Protocol (SMTP), Simple Network Management Protocol (SNMP), Network File Service (NFS) and Network Information Service (NIS), and provides a wired communication environment allowing the security events from the network event generator 100 to be transmitted to the security event processing apparatus 300.

The short distance network includes a wired local area network (LAN) and a wireless local area network (WLAN).

The LAN provides a short distance wired communication environment between the network event generator 100 and the security event processing apparatus 300. The WLAN provides a short distance wireless communication environment such as Wi-Fi between the network event generator 100 and the security event processing apparatus 300.

The security event processing apparatus 300 collects and processes the network events transmitted from the network event generator 100, and delivers them to the visualization processing apparatus 400.

Specifically, the security event processing apparatus 300 classifies the network events according to the kind of security event and searches for organization information based on the classified network events. Furthermore, the security event processing apparatus 300 selects target data for visualization in the classified network events in consideration of the searched organization information and the degree of security threat, delivers the selected target data to the visualization processing apparatus 400.

The visualization processing apparatus 400 visualizes the target data received from the security event processing apparatus 300 to display on the display apparatus 500. Here, the target data may be visualized as single 3D visualization information, e.g., 3D visualization information having a multi-disc structure, providing in real-time network security statuses by organizations such as an internet service provider (ISP) and an autonomous system (AS).

FIG. 2 is a block diagram showing a detailed configuration of the security event processing apparatus 300, which includes a security event classification unit 302, an organization information search unit 304, and a security event summarization unit 306.

The security event classification unit 302 classifies the network events transmitted from the network event generator 100 according to the kind of the security event by checking IP information included in the network events. For example, the network events may be divided into zombie PC logs in a botnet and other security logs (general security logs), because most of the general security logs have source IPs and destination IPs and the zombie PC log only has an IP of zombie PCs infected by a malicious code.

The organization information search unit 304 searches for the organization information based on the network events classified by the security event classification unit 302. That is, the organization information search unit 304 searches for information of an organization to which IPs included in the network events classified as the general security logs belong.

The organization information searched by the organization information search unit 304 may include information of ISP and/or AS.

The security event summarization unit 306 selects target data for visualization among the security logs, in consideration of the searched organization information and the degree of security threat. For the selection of the target data for visualization, several attack detection algorithms and attributes can be used. For example, a target may be selected when the number of attack detection regarding the target is more than a specific value within a specific period of time. As another example, the target may be selected in consideration of both the weak spot score of attack and the amount of attack.

The selected target data is provided from the security event summarization unit 306 to the visualization processing apparatus 400.

FIG. 3 is a block diagram showing a detailed configuration of the visualization processing apparatus 400, which includes a target display radar unit 402, an additional information display unit 404, and a third-dimensional (3D) security visualization unit 406.

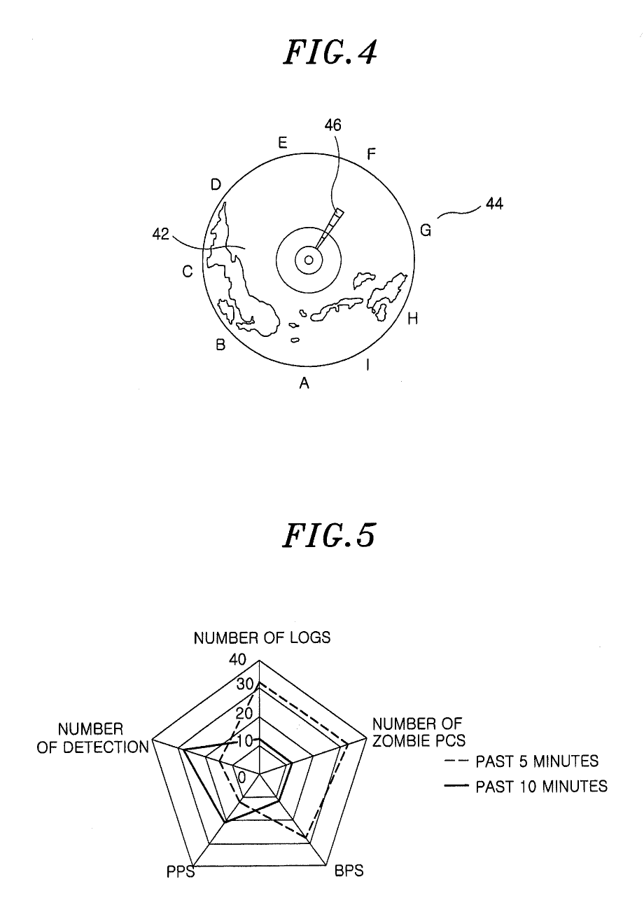

The target display radar unit 402 displays on the display apparatus, e.g., a radar structure, which is shown in FIG. 4, for indicating a target organization displayed by the 3D security visualization unit 406.

Referring to FIG. 4, the radar structure includes a circle 42 denoting a radar, on which names of all organizations 44 to be controlled, e.g., ISP, AS, and the like are displayed. Further a radar needle 46 is included to indicate the target organization displayed through the 3D security visualization unit 406. The radar needle 46 may rotate in a regular speed, and be expressed brighter and wider when the radar needle 46 points at the target organization to be controlled while rotating, in order to highlight the target being displayed in present. Further, the radar needle 46 may move to a specific organization, when a user points at the specific organization using a mouse or touch the specific organization on a touch screen.

The additional information display unit 404 displays on the display apparatus 500 summarized security information regarding the target organization which is displayed by the 3D security visualization unit. The additional information display unit 404 displays, e.g., total sum of the weak spot scores for the target organization, the number of detected zombie PCs, the number of logs, byte per second (BPS) of traffic, packet per second (PPS) of traffic, and the like.

The exemplary display form by the additional information display unit 404 is shown in FIG. 5. Referring to FIG. 5, the number of events of selected target (the number of detection), the number of logs, the number of zombie PCs, BPS and PPS are displayed on a radial graph.

The 3D security visualization unit 406 displays 3D visualization information for representing a security status on the display apparatus 500.

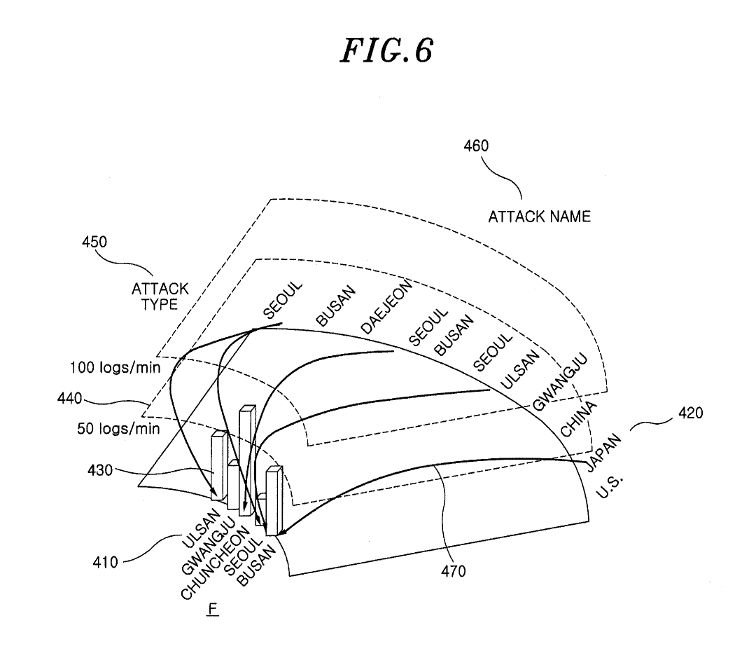

The 3D visualization information may be expressed as a multi-disc structure by the 3D security visualization unit 406, as shown in FIG. 6.

Referring to FIG. 6, the multi-disc structure is formed in a manner that several discs are piled and cut a part thereof. In FIG. 6, coordinates indicated by an arrow 470 on the disc is assumed as a worm or a Sasser worm.

The target organizations to be controlled, which are an ISP symbolized as an ‘F’, can be represented in the inner part 410 of the disc, and all the organizations and foreign countries can be represented in the outer part 420 of the disc. In the inner part 410, the security status can be seen by region. Here, bar graphs 430 are presented around the inner circle of the disc to show the number of detected zombie PCs. Thus, a relation between attack from each organization and the detected zombie PCs can be understood.

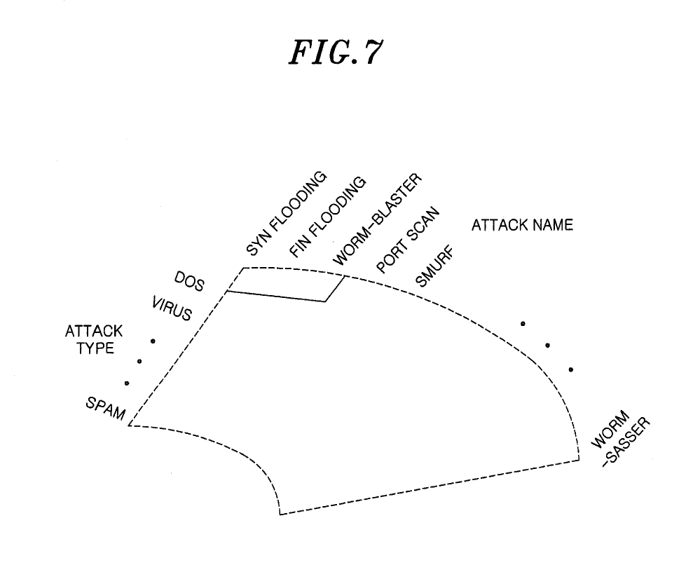

The 3D disc structure displayed by the 3D security visualization unit 406 can be used to express the characteristics by attributes of the security statuses. For example, as shown in FIG. 7, attack types 450 can be represented in the diameter direction of the 3D disc structure, and attack names 460 can be represented in the arc direction. Accordingly, the security status generated in the target organization can be intuitively known according to the attack type and the attack name.

Such a presentation manner, however, is for helping understanding of the embodiment of the present invention, and does not characterize the present invention. For example, the 3D security visualization unit 406 may implement the security status to be acknowledged using port numbers and protocols of destination.

Further, in FIG. 6, the multi-disc structure is used to represent the amount of the security events generated. For example, the upper disc means that the more security events have occurred.

Moreover, the attack situation in the 3D multi-disc structure may be represented as the routes of arrows, i.e., directions and heights of the arrows. For example, as for the arrow 470, it can be seen that the event has occurred in Japan and the attack has been made toward Seoul ISP in Korea (attack direction). Also, it is seen that the attack has been occurred about 60 times per minute (attack amount), and Sasser worm has been used in this attack (attack name).

While the invention has been shown and described with respect to the embodiments, it will be understood by those skilled in the art that various changes and modification may be made without departing from the scope of the invention as defined in the following claims.

What is claimed is:

1. A network security control system, comprising:
a network event generator for generating network events;
a security event processing apparatus for collecting the network events from the network event generator via a network and processing the collected network events as a target data for visualization; and
a visualization processing apparatus for visualizing the target data to display a security status as a third-dimensional (3D) visualization information on an organization basis.

2. The network security control system of claim 1, wherein the network event generator includes at least one among a traffic monitoring device, a firewall system, an intrusion detection system (IDS), an intrusion preventing system (IPS), and a distribute denial of service (DDoS) detection/response system.

3. The network security control system of claim 1, wherein the security event processing apparatus classifies the network events according to the kind of security event, searches for organization information based on the classified network events, and selects target data for visualization among the classified network events in consideration of the searched organization information and the degree of security threat to deliver the selected target data to the visualization processing apparatus.

4. The network security control system of claim 1, wherein the organization includes an internet service provider (ISP) and/or an autonomous system (AS).

5. The network security control system of claim 1, wherein the 3D visualization information is formed on a 3D multi-disc structure.

6. A security event processing apparatus for a control of a network security, comprising:
a security event classification unit for classifying network events supplied thereto into zombie PC logs and other security logs according to the kind of security event;
an organization information search unit for searching for organization information based on the security event classified by the security event classification unit; and
a security event summarization unit for selecting target data for visualization among the security logs, in consideration of the organization information searched by the organization information search unit and the degree of security threat.

7. The security event processing apparatus of claim 6, wherein the organization information search unit searches for information of an organization to which IPs included in the network events classified as the security logs belong.

8. The security event processing apparatus of claim 6, wherein the organization information includes information of an internet service provider (ISP) and/or an autonomous system (AS).

9. The security event processing apparatus of claim 6, wherein the target data for visualization is selected using several attack detection algorithms and attributes.

10. A visualization processing apparatus for a control of a network security, comprising:
a 3D security visualization unit for displaying, on a multi-disc structure, 3D visualization information representing security status of network events;
a target display unit for displaying visualization information indicating a target organization displayed by the 3D security visualization unit; and
an additional information display unit for displaying summarized security information regarding the target organization displayed by the 3D security visualization unit.

11. The visualization processing apparatus of claim 10, wherein the multi-disc structure is formed in a manner that several discs are piled and cut a part thereof.

12. The visualization processing apparatus of claim 10, wherein the 3D visualization information includes a name, a direction, an amount and/or a type of an attack of a zombie PC.

13. The visualization processing apparatus of claim 10, wherein among the 3D visualization information, an attack type is displayed in a diameter direction of the multi-disc structure, and an attack name is displayed in an arc direction of the multi-disc structure.

14. The visualization processing apparatus of claim 10, wherein the target display unit displays the visualization information using a radar structure.

15. The visualization processing apparatus of claim 14, wherein the visualization information using the radar structure includes a radar needle used to highlight the target organization displayed by the 3D security visualization unit.

16. The visualization processing apparatus of claim 10, wherein the target organization is one of an internet service provider (ISP) and an autonomous system (AS).

17. A network security control method, comprising:
classifying network events according to the kind of security event when the network events have occurred;
searching for organization information based on the classified network events;
selecting target data for visualization among the classified network events in consideration of the searched organization information and the degree of security threat; and
displaying the selected target data as 3D visualization information on a multi-disc structure.

18. The network security control method of claim 17, wherein the network events are classified into zombie PC logs and other security logs, and the target data for visualization is selected among the security logs.

19. The network security control method of claim 17, wherein the 3D visualization information includes a name, a direction, an amount and/or a type of an attack of a zombie PC.

20. The network security control method of claim 17, wherein the organization information includes information of an internet service provider (ISP) and/or an autonomous system (AS).
